(19) United States
(12) Patent Application Publication
(10) Pub. No.: US 2025/0062855 A1
(43) Pub. Date: Feb. 20, 2025

(54) APPARATUS, SYSTEM, AND METHOD OF CONFIGURING RATE-DEPENDENT PARAMETERS FOR TRANSMISSION OF A PHYSICAL LAYER (PHY) PROTOCOL DATA UNIT (PPDU)

(71) Applicant: Intel Corporation, Santa Clara, CA (US)

(72) Inventors: Danny Alexander, Monoson (IL); Danny Ben-Ari, Hasharon Hatichon (IL); Michael Shachar, Kfar Glikson (IL)

(73) Assignee: Intel Corporation, Santa Clara, CA (US)

(21) Appl. No.: 18/479,010

(22) Filed: Sep. 30, 2023

Related U.S. Application Data
(60) Provisional application No. 63/520,180, filed on Aug. 17, 2023.

(51) Int. Cl. H04L 1/00

(52) U.S. Cl. CPC H04L 1/0015

(57) ABSTRACT

For example, a wireless communication station (STA) may be configured to determine a selected setting of one or more rate-dependent parameters for transmission of a Physical layer (PHY) Protocol Data Unit (PPDU) based on a minimal Medium Access Control (MAC) Protocol Data Unit (MPDU) size requirement such that, for at least one MPDU of the PPDU, a first count of MAC padding bits to pad the MPDU according to the selected setting of the one or more rate-dependent parameters is less than a second count of MAC padding bits to pad the MPDU according to a channel-based setting of the one or more rate-dependent parameters, wherein, the channel-based setting of the one or more rate-dependent parameters is based on a condition of a wireless communication channel for transmission of the PPDU; and to transmit the PPDU according to a transmission data rate based on the selected setting.

### CROSS REFERENCE

This application claims the benefit of, and priority from, U.S. Provisional Patent Application No. 63/520,180 entitled “APPARATUS, SYSTEM, AND METHOD OF CONFIGURING RATE-DEPENDENT PARAMETERS FOR TRANSMISSION OF A PHYSICAL LAYER (PHY) PROTOCOL DATA UNIT (PPDU)”, filed Aug. 17, 2023, the entire disclosure of which is incorporated herein by reference.

### BACKGROUND

Devices in a wireless communication system may be configured to communicate transmissions with a data rate, which may depend on one or more parameters and/or criteria.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a transmitter mechanism for configuring rate-dependent parameters for transmission of a Physical layer (PHY) Protocol Data Unit (PPDU), in accordance with some demonstrative aspects.

FIG. 3 is a schematic flow-chart illustration of a method of configuring rate-dependent parameters for transmission of a PPDU, in accordance with some demonstrative aspects.

FIG. 4 is a schematic flow-chart illustration of a method of configuring rate-dependent parameters for transmission of a PPDU, in accordance with some demonstrative aspects.

FIG. 5 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December 2020); and/or IEEE 802.11be (IEEE P802.11be/D4.0 Draft Standard for Information technology—Telecommunications and information exchange between systems Local and metropolitan area networks—Specific requirements; Part 11: Wireless LAN Medium Access Control (MAC) and Physical Layer (PHY) Specifications; Amendment 8: Enhancements for extremely high throughput (EHT), July 2023)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band. Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by an mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHZ.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHZ channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHZ, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

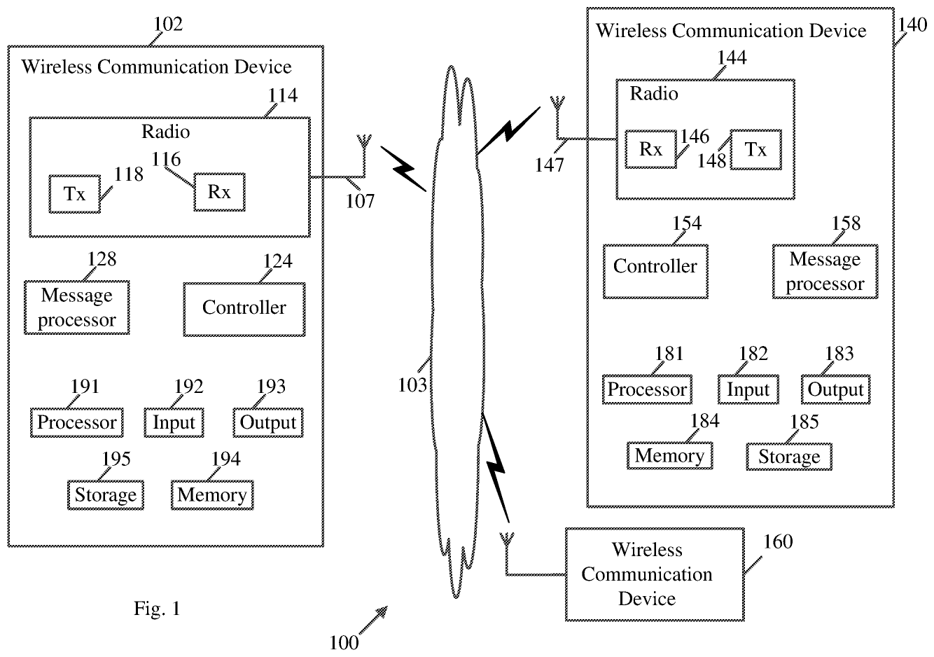

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 160, and/or one more other devices.

In some demonstrative aspects, devices 102, 140, and/or 160 may include a mobile device or a non-mobile, e.g., a static, device.

For example, devices 102, 140, and/or 160 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 160 may be capable of communicating content, data, information and/or signals via a wireless medium (WM) 103. In some demonstrative aspects, wireless medium 103 may include, for example, a radio channel, an RF channel, a WiFi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, a 2.4 GHz wireless communication frequency band, one or more channels in a 5 GHz wireless communication frequency band, and/or one or more channels in a 6 GHz wireless communication frequency band. In another example, WM 103 may additionally or alternatively include one or more channels in an mmWave wireless communication frequency band. In other aspects, WM 103 may include any other type of channel over any other frequency band.

In some demonstrative aspects, device 102, device 140, and/or device 160 may include one or more radios including circuitry and/or logic to perform wireless communication between devices 102, 140, 160, and/or one or more other wireless communication devices. For example, device 102 may include one or more radios 114, and/or device 140 may include one or more radios 144.

In some demonstrative aspects, radios 114 and/or radios 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, and/or any other band, for example, a directional band, e.g., an mmWave band, a 5G band, an SIG band, and/or any other band.

In some demonstrative aspects, radios 114 and/or 144 may include, or may be associated with one or more antennas.

In some demonstrative aspects, device 102 may include one or more antennas 107, and/or device 140 may include on or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 160 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 160 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102, device 140, and/or device 160 may include, operate as, perform the role of, and/or perform one or more functionalities of, one or more STAs. For example, device 102 may include at least one STA, device 140 may include at least one STA, and/or device 160 may include at least one STA.

In some demonstrative aspects, device 102, device 140, and/or device 160 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, device 102, device 140, and/or device 160 may be configured to perform one or more operations, and/or functionalities of a WiFi 8 STA.

In other aspects, for example, devices 102, 140 and/or 160 may be configured to perform one or more operations, and/or functionalities of an Ultra High Reliability (UHR) STA.

In other aspects, for example, devices 102, 140, and/or 160 may be configured to perform one or more operations, and/or functionalities of any other additional or alternative type of STA.

In other aspects, device 102, device 140, and/or device 160 may include, operate as, perform the role of, and/or perform one or more functionalities of, any other wireless device and/or station, e.g., a WLAN STA, a WiFi STA, and the like.

In some demonstrative aspects, device 102, device 140, and/or device 160 may be configured operate as, perform the role of, and/or perform one or more functionalities of, an Access Point (AP), e.g., a High Throughput (HT) AP STA, a High Efficiency (HE) AP STA, an EHT AP STA and/or a UHR AP STA.

In some demonstrative aspects, device 102, device 140, and/or device 160 may be configured to operate as, perform the role of, and/or perform one or more functionalities of, a non-AP STA, e.g., an HT non-AP STA, an HE non-AP STA, an EHT non-AP STA and/or a UHR non-AP STA.

In other aspects, device 102, device 140, and/or device 160 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102, 140, and/or 160 may be configured to communicate in an HT network, an HE network, an EHT network, a UHR network, and/or any other network.

In some demonstrative aspects, devices 102, 140 and/or 160 may be configured to operate in accordance with one or more Specifications, for example, including one or more IEEE 802.11 Specifications, and/or any other specification and/or protocol.

In some demonstrative aspects, device 102 may include, operate as, perform a role of, and/or perform the functionality of, an AP STA.

In some demonstrative aspects, device 140, and/or device 160 may include, operate as, perform a role of, and/or perform the functionality of, one or more non-AP STAs. For example, device 140 may include, operate as, perform a role of, and/or perform the functionality of, at least one non-AP STA, and/or device 160 may include, operate as, perform a role of, and/or perform the functionality of, at least one non-AP STA.

In some demonstrative aspects, device 102, device 140, and/or device 160 may include, operate as, perform a role of, and/or perform the functionality of, a Multi-Link Device (MLD). For example, device 102 may include, operate as, perform a role of, and/or perform the functionality of, at least one MLD, device 140 may include, operate as, perform a role of, and/or perform the functionality of, at least one MLD, and/or device 160 may include, operate as, perform a role of, and/or perform the functionality of, at least one MLD, e.g., as described below.

For example, an MLD may include a device that is a logical entity that is capable of supporting more than one affiliated station (STA) and can operate using one or more affiliated STAs. For example, the MLD may present one Medium Access Control (MAC) data service and a single MAC Service Access Point (SAP) to the Logical Link Control (LLC) sublayer. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102, device 140, and/or device 160 may be configured to operate as, perform the role of, and/or perform one or more functionalities of, an AP MLD.

In some demonstrative aspects, device 102, device 140, and/or device 160 may be configured to operate as, perform the role of, and/or perform one or more functionalities of, a non-AP MLD.

In other aspects, device 102, device 140, and/or device 160 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In some demonstrative aspects, device 102, device 140, and/or device 160 may be configured to apply MAC padding to pad a MAC protocol Data Unit (MPDU) of a PPDU with MAC padding bits, e.g., as described below.

In some demonstrative aspects, device 102, device 140, and/or device 160 may be configured to apply the MAC padding, for example, based on at least one minimal MPDU size requirement, e.g., as described below.

In some demonstrative aspects, the minimal MPDU size requirement may be based on a minimum MPDU start spacing requirement of a receiver of the PPDU, e.g., as described below.

For example, a Minimum MPDU Start Spacing may be defined, e.g., in accordance with an IEEE 802.11 specification, for example, as a minimum time that a receiver of a transmitted PPDU can support between two MPDUs.

In one example, it may be defined, e.g., in accordance with an IEEE 802.11 specification, that a STA shall not start the transmission of more than one MPDU within a time limit described in a Minimum MPDU Start Spacing field declared by an intended receiver. For example, the Minimum MPDU Start Spacing field may be included in a capabilities field received from the intended receiver. For example, a first STA, e.g., implemented by device 140, may identify the Minimum MPDU Start Spacing field in an HT capabilities field or a 6 GHz capabilities field, which may be received from a second STA, e.g., a STA implemented by device 102, which is intended to receive a transmission from the first STA.

In one example, the Minimum MPDU Start Spacing may be set to 4microseconds (μs). In other aspects, any other Minimum MPDU Start Spacing may be used.

In some demonstrative aspects, for example, in some use cases and/or scenarios, there may be a need to address one or more technical issues when complying with the minimal MPDU size requirement, e.g., as described below.

For example, as WiFi throughput evolves with higher order modulations (4K QAM) and wider BWs (320 MHz) the duration of a some MPDUs, e.g., a 1500 Byte (B) MPDU, over the air may become lower than the Minimum MPDU Start Spacing, e.g., less than 4 us. For example, when transmitting at a rate of 5.76 Giga bits per second (Gbps), e.g., corresponding to a 320 MHz BW channel using a Modulation and Coding Scheme (MCS) index of 13 (MCS13), a 1500 Byte MPDU may be transmitted over the air in 2.08 us. This time over the air duration of the MPDU may be much lower than the Minimum MPDU Start Spacing, e.g., 4 usec. As a result, a transmitter STA transmitting the MPDU may be required to pad the MPDU with a relatively large number of additional MAC padding bytes, e.g., in order to comply with the Minimum MPDU Start Spacing requirement. This MAC padding may lead to a relatively large “waste”, e.g., a 48% “waste”, of channel.

For example, transmission of a very short frame, e.g., a single TCP ACK frame of a size of about 100 Bytes, may require about 2700 redundant bytes of padding, e.g., a padding of about 97%.

For example, the transmitter STA may construct Aggregate MAC Service Data Units (MSDUs) (A-MSDUs) to carry multiple MSDUs with a total duration over the air that is greater than the Minimum MPDU Start Spacing requirement. However, A-MSDU construction may not always be possible or sufficient to fully avoid the MAC padding.

In some demonstrative aspects, the minimal MPDU size requirement may be based on a data symbol duration requirement, e.g., as described below.

For example, a data symbol duration may be defined, for example, in accordance with an IEEE 802.11 Specification. For example, it may be defined that a data symbol is to have a particular duration, for example, 12.8 usec+a Guard Interval (GI), e.g., of 0.8, 1.6, or 3.2 usec, for example, for substantially all new modulations and/or band widths.

For example, in some cases and/or scenarios, for example, at a relatively high transmit rate, the minimal MPDU size may be larger than an ordinary user payload. For example, when transmitting at a rate of 5.76 Gps, e.g., corresponding to a 320 MHz BW channel using a Modulation and Coding Scheme (MCS) index of 13(MC13), the minimal payload size may be relatively large, e.g., 5.76 Gbps*13.2 usec=9792 Bytes.

For example, in some use cases and/or scenarios, an actual payload sent by a user may be very small, e.g., 64 Bytes for a TCP ACK. As a result, a large portion of a transmitted frame, e.g., most of the frame, may be padded with a relatively large number of MAC padding bits, e.g., zeros. This MAC padding may be inefficient, e.g., on the transmitter end and/or on the receiver end.

In other aspects, the minimal MPDU size requirement may be based on any other additional or alternative parameter, criterion, and/or requirement.

In some demonstrative aspects, device 102, device 140, and/or device 160 may be configured to implement one or more operations and/or functionalities of a rate-setting mechanism, which may be configured to set one or more rate-dependent parameters of a PPDU, e.g., as described below.

In some demonstrative aspects, the rate-setting mechanism may be configured to provide a technical solution to reduce, e.g., minimize, MAC padding applied to MPDUs of a PPDU, e.g., as described below.

In some demonstrative aspects, the rate-setting mechanism may be configured to provide a technical solution to reduce, e.g., minimize, the MAC padding for example, by reducing, e.g., optimizing, a PHY transmission rate of a PPDU carrying a relatively short MPDU payload, e.g., as described below.

In some demonstrative aspects, the rate-setting mechanism may be configured to provide a technical solution to improve, e.g., maximize, transmission robustness, for example, without substantially sacrificing airtime, e.g., as described below.

In some demonstrative aspects, the rate-setting mechanism may be configured to provide a technical solution to support a smart rate selection, e.g., which may be “aware” of a minimal MPDU size requirement, which may be based, for example, on a Minimum MPDU Start Spacing recipient requirement, and/or a transmit symbol length.

In some demonstrative aspects, the rate-setting mechanism may be configured to provide a technical solution to support the smart rate selection, for example, to reduce a count of MAC padding bits, or to avoid padding the MPDU, for example, by reducing the transmission rate, e.g., be adjusting the MCS, e.g., as described below.

For example, the transmission rate may be reduced to a rate such that the over the air time for transmitting the MPDU may be, for example, equal to or larger than the minimal MPDU size requirement, which may be based, for example, on a Minimum MPDU Start Spacing recipient requirement, and/or a transmit symbol length, e.g., as described below.

In some demonstrative aspects, the rate-setting mechanism may be configured to provide a technical solution to support the smart rate selection, for example, to reduce a count of MAC padding bits, or to avoid padding the MPDU, for example, by selecting a narrower bandwidth for transmission of the PPDU.

In some demonstrative aspects, the rate-setting mechanism may be configured to provide a technical solution to achieve improved performance, e.g., by improving a codding gain, and/or to allow the transmitter to reduce its transmit power.

For example, an MPDU of 1500B transmitted over a 320 MHz channel bandwidth with an MCS index MCS13 may be padded by about 48% extra padding bits, for example, in order to comply with a 4 usec minimal MPDU size requirement, e.g., as described above.

In one example, the transmitter of the PPDU may choose a rate of a lower MCS index, e.g., MCS7, for example, to avoid at least part of the 48% padding. As a result, a channel coding gain of about 15 dB may be achieved.

In another example, the transmitter of the PPDU may choose to use a narrower channel BW for transmission of the PPDU, e.g., a 160 MHz channel BW instead of a 320 MHz channel BW.

In some demonstrative aspects, the rate-setting mechanism may be configured to provide a technical solution to support transmission of an A-MPDU, for example, by taking into account a plurality of MPDUs, e.g., all of the MPDUs, in the A-MPDU.

In some demonstrative aspects, the rate-setting mechanism may be configured to provide a technical solution to support transmission of the A-MPDU, for example, by determining a “sweet spot” of a trade-off between the padding size versus lower rate overhead, for example, to define a rate, e.g., a best rate, for the A-MPDU.

In some demonstrative aspects, the rate-setting mechanism may be configured to provide a technical solution to support improved throughput performance, for example, by improving the signal's quality, e.g., in terms of Error-Vector-Magnitude (EVM) and/or Signal to Noise Ratio (SNR), and/or reducing packet error rate by avoiding redundant retries.

In some demonstrative aspects, the rate-setting mechanism may be configured to provide a technical solution to support a reduced Tx power, e.g., by achieving a substantially same performance with a lower Tx Power.

In some demonstrative aspects, the rate-setting mechanism may be configured to provide a technical solution to improve wireless link robustness to adjacent RF noise.

In some demonstrative aspects, the rate-setting mechanism may be configured to provide a technical solution to improve Network (NW) capacity.

In some demonstrative aspects, the rate-setting mechanism may be configured to provide a technical solution to support a transmitter to utilize different transmission rates and/or different MCS indexes, e.g., based on different packets sizes, for example, in a scenario of substantially fixed channel conditions, e.g., as described below.

In some demonstrative aspects, a wireless communication device, e.g., device 102, device 140, and/or device 160, may include an MLD. For example, at least one affiliated STA of the MLD may be configured to utilize the rate-setting mechanism to communicate over a link utilized by the STA.

In some demonstrative aspects, a wireless communication device, e.g., device 102, device 140, and/or device 160 may be configured to implement one or more operations and/or functionalities of a padding mitigation mechanism, which may be configured to mitigate a number of MAC padding bits to be applied for padding one or more MPDUs, e.g., as described below.

In some demonstrative aspects, the padding mitigation mechanism may implement one or more operations of the rate-setting mechanism to mitigate the number of MAC padding bits to be applied for padding the one or more MPDUs, e.g., as described above.

In some demonstrative aspects, the padding mitigation mechanism may implement one or more operations of one or more additional or alternative mechanisms to mitigate the number of MAC padding bits to be applied for padding the one or more MPDUs, e.g., as described below.

In some demonstrative aspects, the padding mitigation mechanism may implement one or more operations of a coalescing mechanism, which may be configured to coalesce transmission of MSDUs, e.g., via Transmit (Tx) MSDU coalescing, for example, such that a lower number of MAC padding bits is to be used for the coalesced MSDUs.

In some demonstrative aspects, a wireless communication device, e.g., device 102, device 140, and/or device 160 may be configured to identify an MSDU having a size, e.g., which may result in a relatively large number of MAC padding bits.

For example, the wireless communication device may be configured to schedule transmission of the MSDU, e.g., by delaying transmission of the MSDU, for example, to coalesce the transmission of the MSDU with one or more other MSDUs.

For example, the wireless communication device may aggregate the MSDU with one or more additional MSDUs to a common transmission, which may be configured to utilize a reduced number of MAC padding bits.

In some demonstrative aspects, the padding mitigation mechanism may implement one or more operations of a link-selection mechanism, e.g., described below.

In some demonstrative aspects, an MLD, e.g., implemented by device 102, device 140, and/or device 160, may be configured selectively assign MPDUs to links of the MLD, for example, based on a criterion relating to the number of MAC padding bits to be applied to the MPDUs, e.g., described below.

For example, the MLD may be configured to identify an MPDU having a size, e.g., which may result in a relatively large number of MAC padding bits.

For example, the MLD may be select to transmit the MPDU over a link of the MLD, which may have a relatively low Throughput (TPT), e.g., which may support a reduced number of MAC padding bits for padding the MPDU.

In one example, the MLD may be configured to use a low TPT link of the MLD for transmission of MPDUs having a relatively small size, e.g., a size below a size threshold.

In some demonstrative aspects, controller 154 may be configured to control, trigger, cause, and/or instruct a STA implemented by device 140 to determine a selected setting of one or more rate-dependent parameters for transmission of a PPDU, for example, based on a minimal MPDU size requirement, e.g., described below.

In some demonstrative aspects, controller 154 may be configured to control, trigger, cause, and/or instruct the STA implemented by device 140 to determine the selected setting of the one or more rate-dependent parameters for transmission of the PPDU, for example, such that, for at least one MPDU of the PPDU, a first count of MAC padding bits to pad the MPDU according to the selected setting of the one or more rate-dependent parameters may be less than a second count of MAC padding bits to pad the MPDU according to a channel-based setting of the one or more rate-dependent parameters, e.g., as described below.

In some demonstrative aspects, the channel-based setting of the one or more rate-dependent parameters may be based, for example, on a condition of a wireless communication channel for transmission of the PPDU, e.g., as described below.

In some demonstrative aspects, the channel-based setting of the one or more rate-dependent parameters may be configured, for example, to provide a maximal transmission data rate based, for example, on the condition of the wireless communication channel for transmission of the PPDU, e.g., as described below.

In some demonstrative aspects, controller 154 may be configured to control, trigger, cause, and/or instruct the STA implemented by device 140 to transmit the PPDU according to a transmission data rate, which may be based, for example, on the selected setting of the one or more rate-dependent parameters, e.g., as described below.

In some demonstrative aspects, the minimal MPDU size requirement may be based, for example, on a minimum MPDU start spacing requirement of a receiver of the PPDU, e.g., as described below.

In some demonstrative aspects, the minimal MPDU size requirement may be based, for example, on a data symbol duration requirement, e.g., as described below.

In other aspects, the minimal MPDU size requirement may be based on any other additional or alternative parameter and/or criterion.

In some demonstrative aspects, controller 154 may be configured to control, trigger, cause, and/or instruct the STA implemented by device 140 to determine the selected setting of the one or more rate-dependent parameters, for example, such that a PPDU transmission time of the PPDU does not exceed, e.g., by more than a predefined duration, a reference PPDU transmission time, e.g., according to the channel-based setting of the one or more rate-dependent parameters, e.g., as described below.

In some demonstrative aspects, controller 154 may be configured to control, trigger, cause, and/or instruct the STA implemented by device 140 to determine the selected setting of the one or more rate-dependent parameters, for example, such that the transmission data rate based on the selected setting of the one or more rate-dependent parameters is lower than a transmission data rate based on the channel-based setting of the one or more rate-dependent parameters, e.g., as described below.

In some demonstrative aspects, controller 154 may be configured to control, trigger, cause, and/or instruct the STA implemented by device 140 to determine the selected setting of the one or more rate-dependent parameters, for example, by determining a selected MCS index, e.g., as described below.

In some demonstrative aspects, controller 154 may be configured to control, trigger, cause, and/or instruct the STA implemented by device 140 to transmit the PPDU, for example, according to the selected MCS index, e.g., as described below.

In some demonstrative aspects, the selected MCS index may be lower than an MCS index according to the channel-based setting of the one or more rate-dependent parameters, e.g., as described below.

In some demonstrative aspects, the selected MCS index may be a lowest of all MCSs, which result in a PPDU transmission time, e.g., which does not exceed by more than a predefined duration a reference PPDU transmission time according to the channel-based setting of the one or more rate-dependent parameters, e.g., as described below.

In some demonstrative aspects, controller 154 may be configured to control, trigger, cause, and/or instruct the STA implemented by device 140 to determine the selected setting of the one or more rate-dependent parameters, for example, by determining a selected channel Bandwidth (BW), e.g., as described below.

In some demonstrative aspects, controller 154 may be configured to control, trigger, cause, and/or instruct the STA implemented by device 140 to transmit the PPDU over the selected channel BW, e.g., as described below.

In some demonstrative aspects, the selected channel bandwidth may be narrower than a channel BW according to the channel-based setting of the one or more rate-dependent parameters, e.g., as described below.

In some demonstrative aspects, controller 154 may be configured to control, trigger, cause, and/or instruct the STA implemented by device 140 to determine the selected setting of the one or more rate-dependent parameters, for example, by determining a selected number of Spatial Streams (SS), e.g., as described below.

In some demonstrative aspects, controller 154 may be configured to control, trigger, cause, and/or instruct the STA implemented by device 140 to transmit the PPDU over the selected number of SS, e.g., as described below.

In some demonstrative aspects, the selected number of SS may be less than a number of SS according to the channel-based setting of the one or more rate-dependent parameters, e.g., as described below.

In some demonstrative aspects, controller 154 may be configured to control, trigger, cause, and/or instruct the STA implemented by device 140 to determine the selected setting of the one or more rate-dependent parameters, for example, by determining a selected Guard Interval (GI) duration, e.g., as described below.

In some demonstrative aspects, controller 154 may be configured to control, trigger, cause, and/or instruct the STA implemented by device 140 to transmit the PPDU according to the selected GI duration, e.g., as described below.

In some demonstrative aspects, the selected GI duration may be longer than a GI duration according to the channel-based setting of the one or more rate-dependent parameters.

In other aspects, controller 154 may be configured to control, trigger, cause, and/or instruct the STA implemented by device 140 to determine the selected setting of the one or more rate-dependent parameters based on any other additional or alternative criterion, condition, parameter and/or attribute.

In some demonstrative aspects, the PPDU may include an aggregate MPDU (A-MPDU) including a plurality of MPDUs, e.g., as described below.

In some demonstrative aspects, controller 154 may be configured to control, trigger, cause, and/or instruct the STA implemented by device 140 to determine the selected setting of the one or more rate-dependent parameters, for example, based on MAC padding bit counts for the plurality of MPDUs in the A-MPDU, e.g., as described below.

In some demonstrative aspects, controller 154 may be configured to control, trigger, cause, and/or instruct the STA implemented by device 140 to identify an MPDU of a PPDU, for example, based on a first count of MAC padding bits to pad the MPDU according to a first setting of one or more rate-dependent parameters and a minimal MPDU size requirement, e.g., as described below.

In some demonstrative aspects, the minimal MPDU size requirement may be based, for example, on a minimum MPDU start spacing requirement of a receiver of the PPDU, e.g., as described below.

In some demonstrative aspects, the minimal MPDU size requirement may be based, for example, on a data symbol duration requirement, e.g., as described below.

In other aspects, the minimal MPDU size requirement may be based on any other additional or alternative parameter and/or criterion.

In some demonstrative aspects, the first setting of the one or more rate-dependent parameters may be based, for example, on a condition of a wireless communication channel for transmission of the PPDU, e.g., as described below.

In some demonstrative aspects, the first setting of the one or more rate-dependent parameters may be configured, for example, to provide a maximal transmission data rate, for example, based on the condition of the wireless communication channel for transmission of the PPDU, e.g., as described below.

In some demonstrative aspects, controller 154 may be configured to control, trigger, cause, and/or instruct the STA implemented by device 140 to determine a second setting of the one or more rate-dependent parameters, e.g., different from the first setting of the one or more rate-dependent parameters, e.g., as described below.

In some demonstrative aspects, controller 154 may be configured to control, trigger, cause, and/or instruct the STA implemented by device 140 to determine the second setting of the one or more rate-dependent parameters, for example, such that a second count of MAC padding bits to pad the MPDU according to the second setting of the one or more rate-dependent parameters is less than the first count of MAC padding bits, e.g., as described below.

In some demonstrative aspects, controller 154 may be configured to control, trigger, cause, and/or instruct the STA implemented by device 140 to transmit the PPDU, for example, according to a transmission data rate based on the second setting of the one or more rate-dependent parameters, e.g., as described below.

In some demonstrative aspects, the transmission data rate based on the second setting of the one or more rate-dependent parameters may be, for example, lower than a transmission data rate based on the first setting of the one or more rate-dependent parameters, e.g., as described below.

In some demonstrative aspects, controller 154 may be configured to control, trigger, cause, and/or instruct the STA implemented by device 140 to determine the second setting of the one or more rate-dependent parameters, for example, such that a PPDU transmission time of the PPDU does not exceed, e.g., by more than a predefined duration, a reference PPDU transmission time according to the first setting of the one or more rate-dependent parameters, e.g., as described below.

In some demonstrative aspects, controller 154 may be configured to control, trigger, cause, and/or instruct the STA implemented by device 140 to determine the second setting of the one or more rate-dependent parameters, for example, by determining a selected MCS index, e.g., as described below.

In some demonstrative aspects, controller 154 may be configured to control, trigger, cause, and/or instruct the STA implemented by device 140 to transmit the PPDU according to the selected MCS index, e.g., as described below.

In some demonstrative aspects, the selected MCS index may be, for example, lower than an MCS index according to the first setting of the one or more rate-dependent parameters, e.g., as described below.

In some demonstrative aspects, the selected MCS index may be, for example, a lowest of all MCSs, which result in a PPDU transmission time, which does not exceed, e.g., by more than a predefined duration, a reference PPDU transmission time according to the first setting of the one or more rate-dependent parameters, e.g., as described below.

In some demonstrative aspects, controller 154 may be configured to control, trigger, cause, and/or instruct the STA implemented by device 140 to determine the second setting of the one or more rate-dependent parameters by determining a selected channel BW, e.g., as described below.

In some demonstrative aspects, controller 154 may be configured to control, trigger, cause, and/or instruct the STA implemented by device 140 to transmit the PPDU over the selected channel BW, e.g., as described below.

In some demonstrative aspects, the selected channel bandwidth may be, for example, narrower than a channel BW according to the first setting of the one or more rate-dependent parameters, e.g., as described below.

In some demonstrative aspects, controller 154 may be configured to control, trigger, cause, and/or instruct the STA implemented by device 140 to determine the second setting of the one or more rate-dependent parameters, for example, by determining a selected number of SS, e.g., as described below.

In some demonstrative aspects, controller 154 may be configured to control, trigger, cause, and/or instruct the STA implemented by device 140 to transmit the PPDU over the selected number of SS, e.g., as described below.

In some demonstrative aspects, the selected number of SS may be less than a number of SS according to the first setting of the one or more rate-dependent parameters, e.g., as described below.

In some demonstrative aspects, controller 154 may be configured to control, trigger, cause, and/or instruct the STA implemented by device 140 to determine the second setting of the one or more rate-dependent parameters, for example, by determining a selected GI duration, e.g., as described below.

In some demonstrative aspects, controller 154 may be configured to control, trigger, cause, and/or instruct the STA implemented by device 140 to transmit the PPDU according to the selected GI duration, e.g., as described below.

In some demonstrative aspects, the selected GI duration may be, for example, longer than a GI duration according to the first setting of the one or more rate-dependent parameters, e.g., as described below.

In some demonstrative aspects, the PPDU may include an A-MPDU including a plurality of MPDUs, e.g., as described below.

In some demonstrative aspects, controller 154 may be configured to control, trigger, cause, and/or instruct the STA implemented by device 140 to determine the second setting of the one or more rate-dependent parameters, for example, based on MAC padding bit counts for the plurality of MPDUs of the A-MPDU, e.g., as described below.

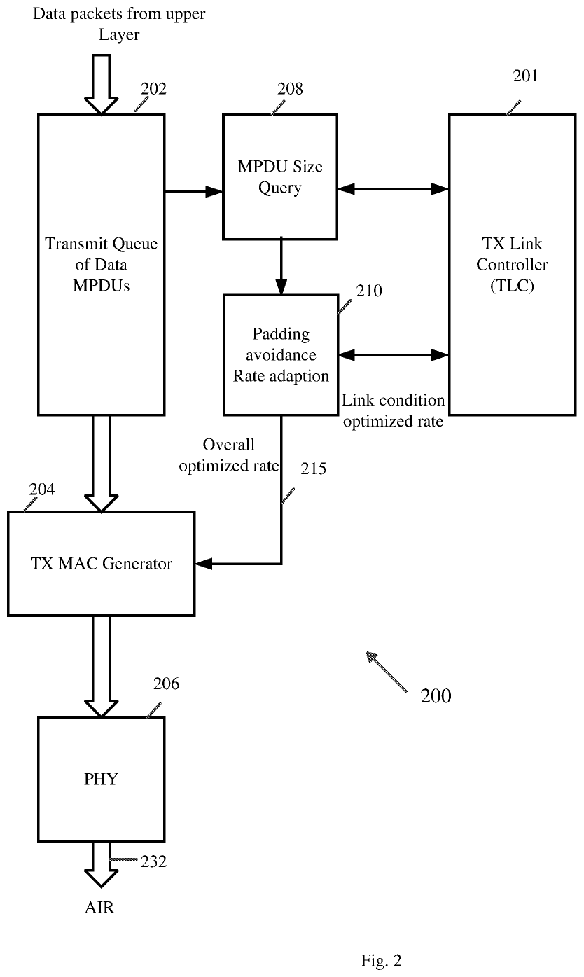

Reference is made to FIG. 2, which schematically illustrates a transmitter mechanism 200 for configuring rate-dependent parameters for transmission of a PPDU 232, in accordance with some demonstrative aspects. For example, controller 154 (FIG. 1) and/or controller 124 (FIG. 1) may be configured to implement one or more elements, operations and/or functionalities of the mechanism of FIG. 2.

In some demonstrative aspects, as shown in FIG. 2, a Tx Link Controller (TLC) 210, e.g., controller 154 (FIG. 1), may be configured to define one or more Tx parameters, including for example, MCS, BW, Number of SS (NSS), symbol size, MPDU density, and/or any other additional or alternative parameters. For example, the TLC 201 may be configured to determine the Tx parameters, for example, based on link conditions of a link for transmission of the PPDU 232, and/or based on receiver side capabilities or a receiver intended to receive the PPDU 232.

In some demonstrative aspects, as shown in FIG. 2, an MPDU Size Query block 208 may be configured to collect information on MPDUs that are about to be transmitted as part of one or more PPDUs 232.

In some demonstrative aspects, the MPDU Size Query block 208 may be configured to determine the size of an MPDU, e.g., each MPDU.

In some demonstrative aspects, MPDU Size Query block 208 may be configured to calculate, e.g., on a per MPDU basis, how many padding bits are to be added to an MPDU to be included in an PPDU 232, for example, due to an MPDU density and/or a symbol size in the transmission.

In some demonstrative aspects, MPDU Size Query block 208 may be configured to calculate the number of padding bits for the MPDU of the PPDU 232, for example, based on the Tx parameters from the TLC 201.

In some demonstrative aspects, as shown in FIG. 2, a padding avoidance rate adaption block 210, e.g., implemented by controller 154 (FIG. 1), may be configured to receive from the MPDU Size Query block 208 the information on the MPDUs.

In some demonstrative aspects, as shown in FIG. 2, padding avoidance rate adaption block 210 may be configured to decide on a manner, e.g., a best way, to reduce an overall padding for an entire transmission, for example, while achieving a gain, e.g., in terms of robustness and/or power, e.g., as described below.

In some demonstrative aspects, the padding avoidance rate adaption block 210 may receive the Tx parameters from the TLC 201.

In some demonstrative aspects, the padding avoidance rate adaption block 210 may be configured to determine selected Tx parameters, for example, including optimized rate-dependent parameters 215, for example, to reduce the overall padding for the PPDU 232, e.g., as described above.

In some demonstrative aspects, the padding avoidance rate adaption block 210 may be configured to select the selected Tx parameters, for example, by selecting a rate, a channel BW, a number of spatial streams, a GI, and/or any other suitable additional or alternative parameter.

In some demonstrative aspects, the padding avoidance rate adaption block 210 may be configured to update the TLC 201 and/or a Tx MAC generator 204, for example, based on the selected Tx parameters 215.

In some demonstrative aspects, as shown in FIG. 2, the Tx MAC Generator 204 may be configured to use the overall optimized selected Tx parameters 215 for transmission of one or more PPDUs 232.

In some demonstrative aspects, as shown in FIG. 2, the Tx MAC Generator 204 may be configured to pass the packets 232 for transmission by a PHY 206.

In some demonstrative aspects, the padding avoidance rate adaption block 210 may be configured to determine the selected Tx parameters 215, e.g., the rate-dependent parameters, for transmission of an A-MPDU in a PPDU 232, e.g., as described below.

In some demonstrative aspects, the padding avoidance rate adaption block 210 may be configured to obtain an indication of a best possible rate for transmission, e.g., from the TLC 201.

For example, the TLC 201 may be configured to determine the best possible rate for transmission, for example, according to current channel conditions.

For example, the padding avoidance rate adaption block 210 may receive from the TLC 201 an indication of one or more rate-dependent parameters, which may be based on the current channel conditions of a channel to be used for transmission of the A-MPDU. For example, the one or more rate-dependent parameters may include an MCS index and/or a GI setting, e.g., based on the current channel conditions.

In some demonstrative aspects, the padding avoidance rate adaption block 210 may be configured to determine a total Tx time for the whole A-MPDU, for example, while applying padding, e.g., to comply with a minimum MPDU spacing receiver capability for the MCS according to the rate selected by the TLC 201, and for a plurality of lower MCSs, e.g., N lower MCSs, which are lower than the MCS according to the rate selected by the TLC.

In some demonstrative aspects, the padding avoidance rate adaption block 210 may be configured to select an MCS to be applied for transmission of the A-MPDU.

In some demonstrative aspects, the padding avoidance rate adaption block 210 may be configured to determine the selected MCS to include a lowest MCS that does not increase the total transmission time of the A-MPDU.

In some demonstrative aspects, the padding avoidance rate adaption block 210 may be configured to select a lowest MCS that does not increase the total transmission time of the A-MPDU, for example, by more than a predefined duration, e.g., a relatively small duration.

For example, the predefined duration may be configured based on a tradeoff between signal robustness and overall Tx time. and/or based on any other additional or alternative criteria.

In some demonstrative aspects, the padding avoidance rate adaption block 210 may be configured to determine selected Tx parameters, e.g., rate-dependent parameters, for transmission of a single MPDU in PPDU 232, e.g., as described below.

In some demonstrative aspects, the padding avoidance rate adaption block 210 may be configured to obtain an indication of a best possible rate for transmission, e.g., from the TLC 201. For example, the TLC 201 may determine the best possible rate for transmission of the single MPDU, for example, according to current channel conditions.

In some demonstrative aspects, the padding avoidance rate adaption block 210 may be configured to select an MCS to be applied for transmission of the MPDU in the PPDU 232.

In some demonstrative aspects, the padding avoidance rate adaption block 210 may be configured to determine the selected MCS to include a lowest MCS that does not substantially extend the transmission time of the MPDU 232, e.g., compared to the time required to transmit the MPDU 232 with a best possible TLC rate.

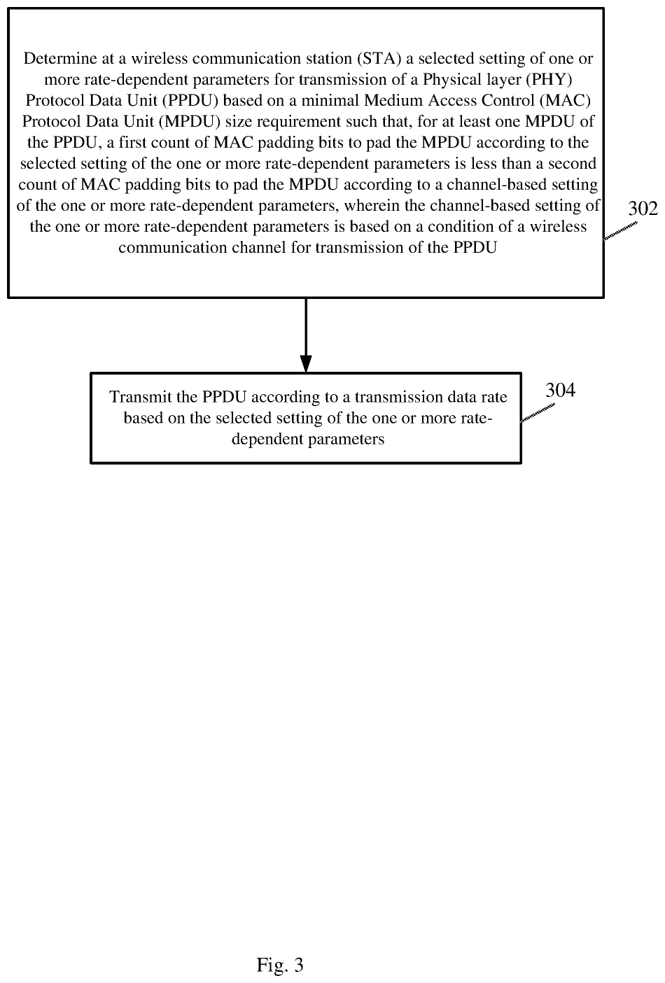

Reference is made to FIG. 3, which schematically illustrates a method of configuring rate-dependent parameters for transmission of a PPDU, in accordance with some demonstrative aspects. For example, one or more of the operations of the method of FIG. 3 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 302, the method may include determining at a STA a selected setting of one or more rate-dependent parameters for transmission of a PPDU based on a minimal MPDU size requirement such that, for at least one MPDU of the PPDU, a first count of MAC padding bits to pad the MPDU according to the selected setting of the one or more rate-dependent parameters is less than a second count of MAC padding bits to pad the MPDU according to a channel-based setting of the one or more rate-dependent parameters. For example, the channel-based setting of the one or more rate-dependent parameters may be based on a condition of a wireless communication channel for transmission of the PPDU. For example, controller 154 (FIG. 1) may be configured to control, trigger, cause, and/or instruct the STA implemented by device 140 (FIG. 1) to determine the selected setting of the one or more rate-dependent parameters for transmission of the PPDU, for example, based on the minimal MPDU size requirement such that, for example, for at least one MPDU of the PPDU, the first count of MAC padding bits to pad the MPDU according to the selected setting of the one or more rate-dependent parameters is less than the second count of MAC padding bits to pad the MPDU according to the channel-based setting of the one or more rate-dependent parameters, e.g., as described above.

As indicated at block 304, the method may include transmitting the PPDU according to a transmission data rate based on the selected setting of the one or more rate-dependent parameters. For example, controller 154 (FIG. 1) may be configured to control, trigger, cause, and/or instruct the STA implemented by device 140 (FIG. 1) to transmit the PPDU according to the transmission data rate based on the selected setting of the one or more rate-dependent parameters, e.g., as described above.

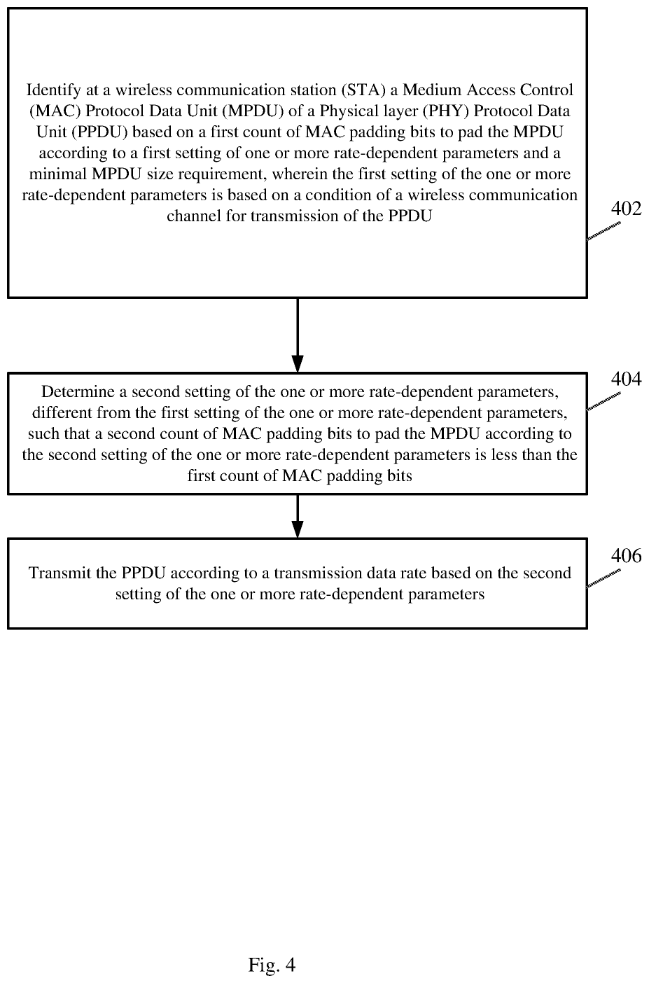

Reference is made to FIG. 4, which schematically illustrates a method of configuring rate-dependent parameters for transmission of a PPDU, in accordance with some demonstrative aspects. For example, one or more of the operations of the method of FIG. 4 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 402, the method may include identifying at a STA an MPDU of a PPDU, for example, based on a first count of MAC padding bits to pad the MPDU according to a first setting of one or more rate-dependent parameters and a minimal MPDU size requirement. For example, the first setting of the one or more rate-dependent parameters may be based on a condition of a wireless communication channel for transmission of the PPDU. For example, controller 154 (FIG. 1) may be configured to control, trigger, cause, and/or instruct the STA implemented by device 140 (FIG. 1) to identify the MPDU of the PPDU, for example, based on the first count of MAC padding bits to pad the MPDU according to the first setting of the one or more rate-dependent parameters and the minimal MPDU size requirement, e.g., as described above.

As indicated at block 404, the method may include determining a second setting of the one or more rate-dependent parameters, e.g., different from the first setting of the one or more rate-dependent parameters, for example, such that a second count of MAC padding bits to pad the MPDU according to the second setting of the one or more rate-dependent parameters is less than the first count of MAC padding bits. For example, controller 154 (FIG. 1) may be configured to control, trigger, cause, and/or instruct the STA implemented by device 140 (FIG. 1) to determine the second setting of the one or more rate-dependent parameters, for example, such that the second count of MAC padding bits to pad the MPDU according to the second setting of the one or more rate-dependent parameters is less than the first count of MAC padding bits, e.g., as described above.

As indicated at block 406, the method may include transmitting the PPDU according to a transmission data rate based on the second setting of the one or more rate-dependent parameters. For example, controller 154 (FIG. 1) may be configured to control, trigger, cause, and/or instruct the STA implemented by device 140 (FIG. 1) to transmit the PPDU according to the transmission data rate based on the second setting of the one or more rate-dependent parameters, e.g., as described above.

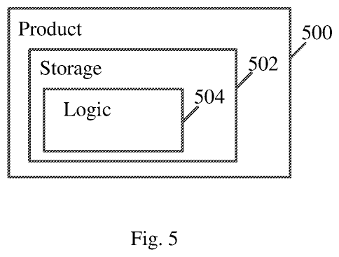

Reference is made to FIG. 5, which schematically illustrates a product of manufacture 500, in accordance with some demonstrative aspects. Product 500 may include one or more tangible computer-readable (“machine-readable”) non-transitory storage media 502, which may include computer-executable instructions, e.g., implemented by logic 504, operable to, when executed by at least one computer processor, enable the at least one computer processor to implement one or more operations at device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1-4, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 500 and/or machine readable storage media 502 may include one or more types of computer-readable storage media capable of storing data, including volatile memory, non-volatile memory, removable or non-removable memory, erasable or non-erasable memory, writeable or re-writeable memory, and the like. For example, machine readable storage media 502 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 504 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 504 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising logic and circuitry configured to cause a wireless communication Station (STA) to determine a selected setting of one or more rate-dependent parameters for transmission of a Physical layer (PHY) Protocol Data Unit (PPDU) based on a minimal Medium Access Control (MAC) Protocol Data Unit (MPDU) size requirement such that, for at least one MPDU of the PPDU, a first count of MAC padding bits to pad the MPDU according to the selected setting of the one or more rate-dependent parameters is less than a second count of MAC padding bits to pad the MPDU according to a channel-based setting of the one or more rate-dependent parameters, wherein the channel-based setting of the one or more rate-dependent parameters is based on a condition of a wireless communication channel for transmission of the PPDU; and transmit the PPDU according to a transmission data rate based on the selected setting of the one or more rate-dependent parameters.

Example 2 includes the subject matter of Example 1, and optionally, wherein the apparatus is configured to cause the STA to determine the selected setting of the one or more rate-dependent parameters by determining a selected Modulation and Coding Scheme (MCS) index, and to transmit the PPDU according to the selected MCS index.

Example 3 includes the subject matter of Example 2, and optionally, wherein the selected MCS index is lower than an MCS index according to the channel-based setting of the one or more rate-dependent parameters.

Example 4 includes the subject matter of Example 2 or 3, and optionally, wherein the selected MCS index is a lowest of all MCSs, which result in a PPDU transmission time, which does not exceed by more than a predefined duration a reference PPDU transmission time according to the channel-based setting of the one or more rate-dependent parameters.

Example 5 includes the subject matter of any one of Examples 1-4, and optionally, wherein the apparatus is configured to cause the STA to determine the selected setting of the one or more rate-dependent parameters by determining a selected channel Bandwidth (BW), and to transmit the PPDU over the selected channel BW.

Example 6 includes the subject matter of Example 5, and optionally, wherein the selected channel bandwidth is narrower than a channel BW according to the channel-based setting of the one or more rate-dependent parameters.

Example 7 includes the subject matter of any one of Examples 1-6, and optionally, wherein the apparatus is configured to cause the STA to determine the selected setting of the one or more rate-dependent parameters by determining a selected number of Spatial Streams (SS), and to transmit the PPDU over the selected number of SS.

Example 8 includes the subject matter of Example 7, and optionally, wherein the selected number of SS is less than a number of SS according to the channel-based setting of the one or more rate-dependent parameters.

Example 9 includes the subject matter of any one of Examples 1-8, and optionally, wherein the apparatus is configured to cause the STA to determine the selected setting of the one or more rate-dependent parameters by determining a selected Guard Interval (GI) duration, and to transmit the PPDU according to the selected GI duration.

Example 10 includes the subject matter of Example 9, and optionally, wherein the selected GI duration is longer than a GI duration according to the channel-based setting of the one or more rate-dependent parameters.

Example 11 includes the subject matter of any one of Examples 1-10, and optionally, wherein the PPDU comprises an aggregate MPDU (A-MPDU) comprising a plurality of MPDUs.

Example 12 includes the subject matter of Example 11, and optionally, wherein the apparatus is configured to cause the STA to determine the selected setting of the one or more rate-dependent parameters based on MAC padding bit counts for the plurality of MPDUs.

Example 13 includes the subject matter of any one of Examples 1-12, and optionally, wherein the apparatus is configured to cause the STA to determine the selected setting of the one or more rate-dependent parameters such that a PPDU transmission time of the PPDU does not exceed by more than a predefined duration a reference PPDU transmission time according to the channel-based setting of the one or more rate-dependent parameters.

Example 14 includes the subject matter of any one of Examples 1-13, and optionally, wherein the minimal MPDU size requirement is based on a minimum MPDU start spacing requirement of a receiver of the PPDU.

Example 15 includes the subject matter of any one of Examples 1-14, and optionally, wherein the minimal MPDU size requirement is based on a data symbol duration requirement.

Example 16 includes the subject matter of any one of Examples 1-15, and optionally, wherein the transmission data rate based on the selected setting of the one or more rate-dependent parameters is lower than a transmission data rate based on the channel-based setting of the one or more rate-dependent parameters.

Example 17 includes the subject matter of any one of Examples 1-16, and optionally, wherein the channel-based setting of the one or more rate-dependent parameters is to provide a maximal transmission data rate based on the condition of the wireless communication channel for transmission of the PPDU.

Example 18 includes the subject matter of any one of Examples 1-17, and optionally, comprising a radio to transmit the PPDU.

Example 19 includes the subject matter of Example 18, and optionally, comprising one or more antennas connected to the radio, and a processor to execute instructions of an operating system of the STA.

Example 20 includes an apparatus comprising logic and circuitry configured to cause a wireless communication Station (STA) to identify a Medium Access Control (MAC) Protocol Data Unit (MPDU) of a Physical layer (PHY) Protocol Data Unit (PPDU) based on a first count of MAC padding bits to pad the MPDU according to a first setting of one or more rate-dependent parameters and a minimal MPDU size requirement, wherein the first setting of the one or more rate-dependent parameters is based on a condition of a wireless communication channel for transmission of the PPDU; determine a second setting of the one or more rate-dependent parameters, different from the first setting of the one or more rate-dependent parameters, such that a second count of MAC padding bits to pad the MPDU according to the second setting of the one or more rate-dependent parameters is less than the first count of MAC padding bits; and transmit the PPDU according to a transmission data rate based on the second setting of the one or more rate-dependent parameters.

Example 21 includes the subject matter of Example 20, and optionally, wherein the apparatus is configured to cause the STA to determine the second setting of the one or more rate-dependent parameters by determining a selected Modulation and Coding Scheme (MCS) index, and to transmit the PPDU according to the selected MCS index.

Example 22 includes the subject matter of Example 21, and optionally, wherein the selected MCS index is lower than an MCS index according to the first setting of the one or more rate-dependent parameters.

Example 23 includes the subject matter of Example 21 or 22, and optionally, wherein the selected MCS index is a lowest of all MCSs, which result in a PPDU transmission time, which does not exceed by more than a predefined duration a reference PPDU transmission time according to the first setting of the one or more rate-dependent parameters.

Example 24 includes the subject matter of any one of Examples 20-23, and optionally, wherein the apparatus is configured to cause the STA to determine the second setting of the one or more rate-dependent parameters by determining a selected channel Bandwidth (BW), and to transmit the PPDU over the selected channel BW.

Example 25 includes the subject matter of Example 24, and optionally, wherein the selected channel bandwidth is narrower than a channel BW according to the first setting of the one or more rate-dependent parameters.

Example 26 includes the subject matter of any one of Examples 20-25, and optionally, wherein the apparatus is configured to cause the STA to determine the second setting of the one or more rate-dependent parameters by determining a selected number of Spatial Streams (SS), and to transmit the PPDU over the selected number of SS.

Example 27 includes the subject matter of Example 26, and optionally, wherein the selected number of SS is less than a number of SS according to the first setting of the one or more rate-dependent parameters.

Example 28 includes the subject matter of any one of Examples 20-27, and optionally, wherein the apparatus is configured to cause the STA to determine the second setting of the one or more rate-dependent parameters by determining a selected Guard Interval (GI) duration, and to transmit the PPDU according to the selected GI duration.

Example 29 includes the subject matter of Example 28, and optionally, wherein the selected GI duration is longer than a GI duration according to the first setting of the one or more rate-dependent parameters.

Example 30 includes the subject matter of any one of Examples 20-29, and optionally, wherein the PPDU comprises an aggregate MPDU (A-MPDU) comprising a plurality of MPDUs.

Example 31 includes the subject matter of Example 30, and optionally, wherein the apparatus is configured to cause the STA to determine the second setting of the one or more rate-dependent parameters based on MAC padding bit counts for the plurality of MPDUs.

Example 32 includes the subject matter of any one of Examples 20-31, and optionally, wherein the apparatus is configured to cause the STA to determine the second setting of the one or more rate-dependent parameters such that a PPDU transmission time of the PPDU does not exceed by more than a predefined duration a reference PPDU transmission time according to the first setting of the one or more rate-dependent parameters.

Example 33 includes the subject matter of any one of Examples 20-32, and optionally, wherein the minimal MPDU size requirement is based on a minimum MPDU start spacing requirement of a receiver of the PPDU.

Example 34 includes the subject matter of any one of Examples 20-33, and optionally, wherein the minimal MPDU size requirement is based on a data symbol duration requirement.

Example 35 includes the subject matter of any one of Examples 20-34, and optionally, wherein the transmission data rate based on the second setting of the one or more rate-dependent parameters is lower than a transmission data rate based on the first setting of the one or more rate-dependent parameters.

Example 36 includes the subject matter of any one of Examples 20-35, and optionally, wherein the first setting of the one or more rate-dependent parameters is to provide a maximal transmission data rate based on the condition of the wireless communication channel for transmission of the PPDU.

Example 37 includes the subject matter of any one of Examples 20-36, and optionally, comprising a radio to transmit the PPDU.

Example 38 includes the subject matter of Example 37, and optionally, comprising one or more antennas connected to the radio, and a processor to execute instructions of an operating system of the STA.

Example 39 comprises a wireless communication device comprising the apparatus of any of Examples 1-38.

Example 40 comprises a mobile device comprising the apparatus of any of Examples 1-38.

Example 41 comprises an apparatus comprising means for executing any of the described operations of any of Examples 1-38.

Example 42 comprises a product comprising one or more tangible computer-readable non-transitory storage media comprising instructions operable to, when executed by at least one processor, enable the at least one processor to cause a wireless communication device to perform any of the described operations of any of Examples 1-38.

Example 43 comprises an apparatus comprising: a memory interface; and processing circuitry configured to: perform any of the described operations of any of Examples 1-38.

Example 44 comprises a method comprising any of the described operations of any of Examples 1-38.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a wireless communication Station (STA) to:
determine a selected setting of one or more rate-dependent parameters for transmission of a Physical layer (PHY) Protocol Data Unit (PPDU) based on a minimal Medium Access Control (MAC) Protocol Data Unit (MPDU) size requirement such that, for at least one MPDU of the PPDU, a first count of MAC padding bits to pad the MPDU according to the selected setting of the one or more rate-dependent parameters is less than a second count of MAC padding bits to pad the MPDU according to a channel-based setting of the one or more rate-dependent parameters, wherein the channel-based setting of the one or more rate-dependent parameters is based on a condition of a wireless communication channel for transmission of the PPDU; and
transmit the PPDU according to a transmission data rate based on the selected setting of the one or more rate-dependent parameters.

2. The apparatus of claim 1 configured to cause the STA to determine the selected setting of the one or more rate-dependent parameters by determining a selected Modulation and Coding Scheme (MCS) index, and to transmit the PPDU according to the selected MCS index.

3. The apparatus of claim 2, wherein the selected MCS index is lower than an MCS index according to the channel-based setting of the one or more rate-dependent parameters.

4. The apparatus of claim 2, wherein the selected MCS index is a lowest of all MCSs, which result in a PPDU transmission time, which does not exceed by more than a predefined duration a reference PPDU transmission time according to the channel-based setting of the one or more rate-dependent parameters.

5. The apparatus of claim 1 configured to cause the STA to determine the selected setting of the one or more rate-dependent parameters by determining a selected channel Bandwidth (BW), and to transmit the PPDU over the selected channel BW.

6. The apparatus of claim 5, wherein the selected channel bandwidth is narrower than a channel BW according to the channel-based setting of the one or more rate-dependent parameters.

7. The apparatus of claim 1 configured to cause the STA to determine the selected setting of the one or more rate-dependent parameters by determining a selected number of Spatial Streams (SS), and to transmit the PPDU over the selected number of SS.

8. The apparatus of claim 7, wherein the selected number of SS is less than a number of SS according to the channel-based setting of the one or more rate-dependent parameters.

9. The apparatus of claim 1 configured to cause the STA to determine the selected setting of the one or more rate-dependent parameters by determining a selected Guard Interval (GI) duration, and to transmit the PPDU according to the selected GI duration.

10. The apparatus of claim 9, wherein the selected GI duration is longer than a GI duration according to the channel-based setting of the one or more rate-dependent parameters.

11. The apparatus of claim 1, wherein the PPDU comprises an aggregate MPDU (A-MPDU) comprising a plurality of MPDUs.

12. The apparatus of claim 11 configured to cause the STA to determine the selected setting of the one or more rate-dependent parameters based on MAC padding bit counts for the plurality of MPDUs.

13. The apparatus of claim 1 configured to cause the STA to determine the selected setting of the one or more rate-dependent parameters such that a PPDU transmission time of the PPDU does not exceed by more than a predefined duration a reference PPDU transmission time according to the channel-based setting of the one or more rate-dependent parameters.

14. The apparatus of claim 1, wherein the minimal MPDU size requirement is based on a minimum MPDU start spacing requirement of a receiver of the PPDU.

15. The apparatus of claim 1, wherein the minimal MPDU size requirement is based on a data symbol duration requirement.

16. The apparatus of claim 1 comprising a radio to transmit the PPDU.

17. The apparatus of claim 16 comprising one or more antennas connected to the radio, and a processor to execute instructions of an operating system of the STA.

18. A product comprising one or more tangible computer-readable non-transitory storage media comprising instructions operable to, when executed by at least one processor, enable the at least one processor to cause a wireless communication Station (STA) to:
identify a Medium Access Control (MAC) Protocol Data Unit (MPDU) of a Physical layer (PHY) Protocol Data Unit (PPDU) based on a first count of MAC padding bits to pad the MPDU according to a first setting of one or more rate-dependent parameters and a minimal MPDU size requirement, wherein the first setting of the one or more rate-dependent parameters is based on a condition of a wireless communication channel for transmission of the PPDU;
determine a second setting of the one or more rate-dependent parameters, different from the first setting of the one or more rate-dependent parameters, such that a second count of MAC padding bits to pad the MPDU according to the second setting of the one or more rate-dependent parameters is less than the first count of MAC padding bits; and
transmit the PPDU according to a transmission data rate based on the second setting of the one or more rate-dependent parameters.

19. The product of claim 18, wherein the instructions, when executed, cause the STA to determine the second setting of the one or more rate-dependent parameters by determining a selected Modulation and Coding Scheme (MCS) index, and to transmit the PPDU according to the selected MCS index.

20. The product of claim 18, wherein the first setting of the one or more rate-dependent parameters is to provide a maximal transmission data rate based on the condition of the wireless communication channel for transmission of the PPDU.
